(19) United States
(12) Patent Application Publication
(10) Pub. No.: US 2015/0118530 A1
(43) Pub. Date: Apr. 30, 2015

(54) Battery Pack

(71) Applicant: SAMSUNG SDI CO., LTD., Yongin-si (KR)

(72) Inventor: Do-Hyung LEE, Yongin-si (KR)

(21) Appl. No.: 14/463,096

(22) Filed: Aug. 19, 2014

(30) Foreign Application Priority Data
Oct. 28, 2013 (KR) 10-2013-0128643

(51) Int. Cl. H01M 10/6561; H01M 2/10; H01M 10/48

(52) U.S. Cl. CPC H01M 10/5063; H01M 10/486; H01M 10/482; H01M 2/105; H01M 2220/30
USPC 429/82

(57) ABSTRACT

A battery pack includes battery cells in a plurality of neighboring rows arranged in a first direction, each row of the neighboring rows including a plurality of the battery cells arranged in a second direction, a holder between the neighboring rows of the battery cells, the holder having a first surface contacting a side surface of each of the battery cells forming a first row among the neighboring rows and a second surface contacting a side surface of each of the battery cells forming a second row among the neighboring rows, and a temperature device that measures a temperature of the battery cells. The holder includes a receiving groove extending inwardly from at least one of the first surface and the second surface of the holder to receive the temperature device, and a cooling hole that passes through the holder to enable a fluid to enter and exit the holder.

### CROSS-REFERENCE TO RELATED APPLICATION

Korean Patent Application No. 10-2013-0128643, filed on Oct. 28, 2013, in the Korean Intellectual Property Office, and entitled: “Battery Pack,” is incorporated by reference herein in its entirety.

### BACKGROUND

1. Field

One or more embodiments relate to a battery pack.

2. Description of the Related Art

Secondary batteries are rechargeable unlike primary batteries that are not rechargeable. The secondary batteries are widely used not only in small high-tech electronic devices, such as mobile phones, personal digital assistants (PDAs), and notebook computers, but also in energy storage systems.

### SUMMARY

Embodiments are directed to a battery pack including battery cells in a plurality of neighboring rows arranged in a first direction, each row of the neighboring rows including a plurality of the battery cells arranged in a second direction, a holder between the neighboring rows of the battery cells, the holder having a first surface contacting a side surface of each of the battery cells forming a first row among the neighboring rows and a second surface contacting a side surface of each of the battery cells forming a second row among the neighboring rows, and a temperature device that measures a temperature of the battery cells. The holder includes a receiving groove extending inwardly from at least one of the first surface and the second surface of the holder to receive the temperature device, and a cooling hole that passes through the holder to enable a fluid to enter and exit the holder.

A depth of the receiving groove from the first surface or the second surface of the holder may be equal to or less than a thickness of the temperature device.

The receiving groove may be a first receiving groove. The temperature device may be connected to a wire that extends toward an outside. The holder may further include a second receiving groove that is coupled to the first receiving groove and receives the wire.

The first row and the second row may each include outer battery cells at respective outer sides of the first row and the second row and one or more inner battery cells located inwardly from the outer battery cells in the first row and the second row. The temperature device may contact the side surface of an inner battery cell among the one or more inner battery cells in the first row or the second row.

The battery cells may be cylindrical battery cells each extending in a third direction orthogonal to the first direction and the second direction. The holder may have a height in the third direction greater than or equal to a height of the battery cells.

The cooling hole may pass through the holder in the third direction.

The first surface and the second surface of the holder may include recesses, each conforming to the side surface of one of the battery cells.

The holder may further include stoppers that contact at least one of top surfaces and bottom surfaces of the battery cells of the first row and the second row.

The battery pack may further include a bus bar that electrically connects the battery cells, the bus bar covering the battery cells and the holder and including a hole formed at a position corresponding to the cooling hole.

The fluid that is enabled by the cooling hole to enter and exit the holder may be air.

The battery pack may further include a pair of end holders at respective ends of the battery pack in the first direction, the pair of end holders and the holder being coupled by a coupling member that passes in the first direction through the pair of end holders and the holder.

The holder may include a first edge portion and a second edge portion at respective ends of the holder in the second direction and a partition portion that couples the first edge portion and the second edge portion, the partition portion including the receiving groove and the cooling hole.

Each of the first edge portion and the second edge portion may protrude in the first direction from the partition portion toward the battery cells forming the first row and toward the battery cells forming the second row.

Each of the first edge portion and second edge portion may protrude in the first direction toward the battery cells forming the first row by a distance corresponding to a radius of the battery cells of the first row and protrudes in the first direction toward the battery cells forming the second row by a distance corresponding to a radius of the battery cells of the second row.

The coupling member may include a plurality of coupling members. Respective ones of the coupling members may pass through the first edge portion or the second edge portion of the holder

The battery cells may be cylindrical. The partition portion may include recesses conforming to the side surfaces of the battery cells of the first row and the second row. The partition portion may include a relatively thick portion and a relatively thin portion, the relatively thin portion being formed by the recesses.

The cooling hole may be formed at the relatively thick portion.

The neighboring rows of the battery cells may include include three or more rows of the battery cells. The holder may include a plurality of adjacent holders, each of the holders being between the neighboring rows of the battery cells. The first edge portion of the adjacent holders may contact each other and the second edge portion of the adjacent holders may contact each other.

The relatively thick portion of each of the adjacent holders may contact each other.

### BRIEF DESCRIPTION OF THE DRAWINGS

Features will become apparent to those of skill in the art by describing in detail exemplary embodiments with reference to the attached drawings in which:

FIG. 1 illustrates a schematic perspective view of a battery pack according to an embodiment;

FIG. 2 illustrates a detailed perspective view depicting a holder and a temperature unit illustrated in FIG. 1;

FIG. 3 illustrates a front view of the holder depicted in FIG. 2;

FIG. 4 illustrates a perspective view taken along line IV-IV in FIG. 2; and

FIG. 5 illustrates a detailed perspective view depicting end holders according to an embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. Like reference numerals refer to like elements throughout.

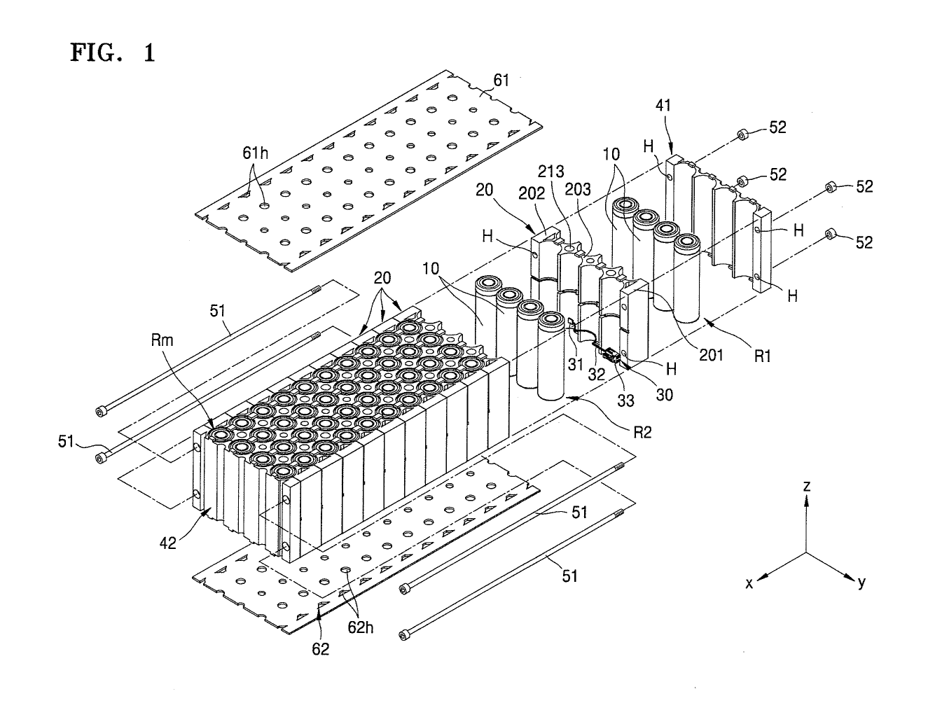

FIG. 1 illustrates a schematic perspective view of a battery pack according to an embodiment.

Referring to FIG. 1, the battery pack may include battery cells 10 forming a plurality of rows, a holder 20 interposed between neighboring rows of battery cells 10, a temperature unit 30 that obtains temperature information of the battery cell 10, a pair of end holders 41 and 42 disposed at an outermost portion of the battery cells 10, coupling members 51 and 52, and first and second bus bars 61 and 62 that electrically couple the battery cells 10.

The battery cells 10 may be cylindrical. For example, as illustrated in FIG. 1, the battery cells 10 may have a cylindrical shape that extends in a third direction (z direction in FIG. 1) that is perpendicular to first and second directions. The holder may have a height in the z direction that is greater than or equal to a height of the battery cells 10 in the z direction.

The battery cells 10 may be rechargeable battery cells. For example, the battery cells 10 may be nickel-cadmium (Ni—Cd) battery cells, nickel-hydrogen (Ni—H) battery cells, or lithium (Li) ion battery cells. A lithium ion battery cell has an operation voltage that is three times higher than the operation voltage of a nickel-cadmium battery cell or a nickel-hydrogen battery cell. Accordingly, the lithium ion battery may be widely used as a power supply for portable electronic equipment. The lithium ion battery has a high energy density per unit weight, and may be used for various purposes.

The battery cells 10 may form a plurality of rows. For example, four battery cells 10 may be arranged in the first direction (y direction in FIG. 1) to form a row of battery cells 10. When the battery cells 10 are disposed in this manner, the battery cells 10 may form a plurality of rows R1, R2, . . . , Rm. The rows R1, R2, . . . , Rm may be disposed in parallel to each other in the second direction (x direction in FIG. 1) across the first direction.

Although the present embodiment illustrates a case where four battery cells 10 form one row, in other implementations, two or more battery cells 10 may form one row.

In this specification, for the convenience of description, a set of battery cells 10 forming one of row of adjacent battery cells is designated as a first row R1, and a set of battery cells 10 forming an adjacent one of the rows is designated as a second row R2.

The holder 20 may be disposed between neighboring rows, for example, between the first row R1 and the second row R2. The holder 20 may directly contact the side surfaces of the battery cells 10 forming the first and second rows R1 and R2 while being disposed between the first row R1 and the second row R2. A first surface of the holder 20 may contact the side surfaces of the battery cells 10 forming the first row R1, and a second surface of the holder 20, which is opposite to the first surface, may contact the side surfaces of the battery cells 10 forming the second row R2.

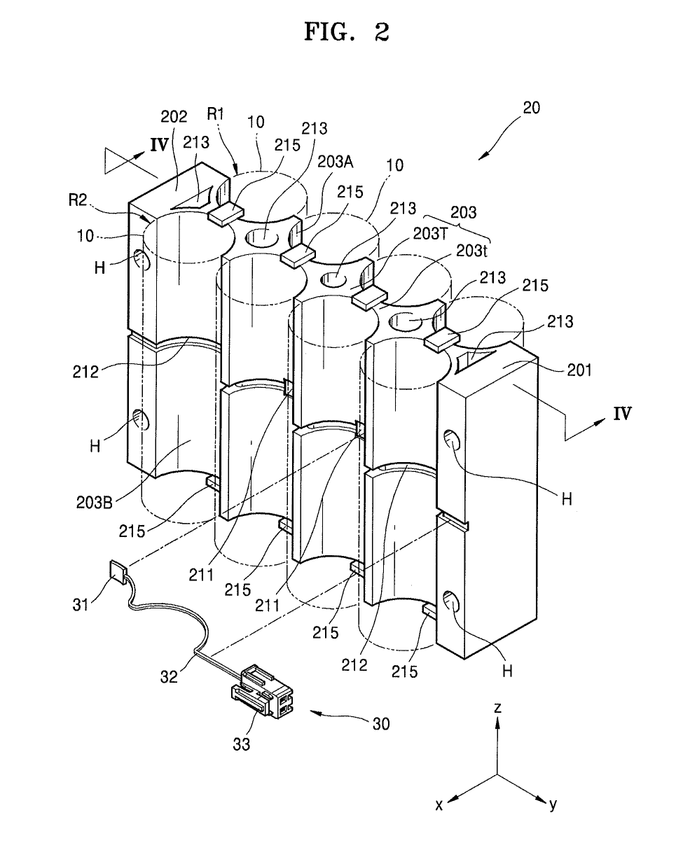

At least one of a first surface 203A (see FIG. 2) and a second surface 203B (see FIG. 2) of the holder 20 may include a first receiving groove 211 (see FIG. 2) that receives a temperature device 31 (see FIG. 2). For example, the temperature device 31 may be received in the first receiving groove 211 formed on the first surface of the holder 20. The holder 20 and the row (first row R1 or second row R2) of battery cells 10 may contact each other while the temperature device 31 is received in the first receiving groove 211 of the holder 20. Accordingly, the temperature device 31 may obtain temperature information with respect to the side surface of the battery cell 10.

A top surface and a bottom surface of the battery cell 10 may be exposed to the outside. Accordingly, heat of the battery cell 10 may be easily dissipated by external air or may be transmitted to a component such as a bus bar. Therefore, if the temperature were to be measured by a temperature device that contacts the top surface of the battery cell 10, such temperature measurement may fail to fully reflect the actual temperature resulting from the heating of the battery cell 10.

According to an embodiment, the first receiving groove 211 configured to receive the temperature device 31 may be provided on at least one of the first and second surfaces 203A and 203B contacting the side surface of the battery cell 10. Accordingly, the temperature device 31 may measure the temperature of the side surface of the battery cell 10. The temperature measurement taken at the side surface of the battery cell 10 may be less affected by other external components than the temperature measurements taken at the top surface or the bottom surface of the battery cell 10. Therefore, the temperature device 31 may be disposed to measure the temperature of the battery cell 10 relatively accurately.

The temperature unit 30 may include the temperature device 31 that measure the temperature of the battery cell 10, and a wire 32 and a connector 33 that transmit the measured temperature information to the outside.

The temperature device 31 may be a thermistor, such as, for example, a resistive thermistor that has an electrical resistance that varies according to temperatures. The thermistor may generate an electrical signal corresponding to the temperature of the battery cell 10 to be measured.

The generated electrical signal may be transmitted to a protection circuit module (not illustrated) through the wire 32 and the connector 33 that are connected to one end of the temperature device 31. The transmitted signal may be used to monitor a temperature change of the battery cell 10 and control a charge/discharge operation of the battery cell 10. Based on the temperature information received from the temperature device 31, the protection circuit module may prevent overheating and explosion that may be caused by an overcharge, overdischarge, or overcurrent of the battery cells 10. To this end, the protection circuit module may include a protection device. The protection device may selectively include safety elements, for example, passive elements such as resistors and capacitors or active elements such as field-effect transistors, or integrated circuits.

The holder 20 may include a cooling hole 213 that extends in a direction identical or parallel to the extension direction (longitudinal direction, z direction) of the battery cell 10. As will be described later, the holder 20 may be assembled to directly contact the battery cells 10 forming neighboring rows while being disposed between the neighboring rows. Heat may be generated when the battery cell 10 is repeatedly charged and discharged. When the generated heat is not dissipated, the battery cell 10 may become overheated and may not perform a normal operation. In order to prevent an abnormal operation of the battery cell 10 due to the overheating, the holder 20 may include the cooling hole 213 that is disposed between the adjacent rows.

The pair of end holders 41 and 42 may be disposed at the outermost portion of the battery cells 10 that are arranged to form rows and columns. For example, the pair of end holders 41 and 42 may include a first end holder 41 that is disposed adjacent to one end row of the battery cells 10, and a second end holder 42 that is disposed adjacent to the other end row of the battery cells 10 to face the first end holder 41.

One surface of the first end holder 41 may directly contact the first row R1. For example, one surface of the first end holder 41 may be disposed to directly contact and face the side surfaces of the battery cells 10 forming the first row R1.

One surface of the second end holder 42 may directly contact the m-th row Rm that is at an opposite end of the battery pack from the first row R1. For example, one surface of the second end holder 42 may be disposed to directly contact and face the side surfaces of the battery cells 10 forming the m-th row Rm.

The first end holder 41 and the second end holder 42 may be mechanically coupled by coupling members 51 and 52 while the first end holder 41 and the second end holder 42 are disposed at the outermost portions of the battery cells 10. After disposing the first and second end holders 41 and 42 at the outermost portions of the battery cells 10 having the holder 20 between the neighboring cells, by using the coupling members 51 and 52, the battery cells 10, the holder 20, and the first and second end holders 41 and 42 may be coupled to form one united body.

The coupling members 51 and 52 may include a bar-type bolt 51 that extends through the first and second end holders 41 and 42 and the holder 20, and a nut 52 that is coupled to one end of the bolt 51. The battery cells 10, the holder 20, and the first and second end holders 41 and 42 may be coupled in one united body by coupling the nut 52 and one end of the bolt 51 after inserting the bolt 51 into a through hole H formed at the holder 20 and the first and second holders 41 and 42 such that the bolt 51 passes through the holder 20 and the first and second holders 41 and 42.

The first and second bus bars 61 and 62 may be disposed respectively at the positions corresponding to the top surface and the bottom surface of the battery cells 10, and may electrically couple the battery cells 10. For example, the battery cells 10 may be connected in parallel by welding the first bus bar 61 to the top surface of the battery cells 10 and welding the second bus bar 62 to the bottom surface of the battery cells 10.

The first bus bar 61 may include a hole 61h that is formed at a position corresponding to the cooling hole 213 formed at the holder 20. As described above, the first bus bar 61 may be welded onto the top surface of the battery cells 10. If the hole 61h were not formed at the first bus bar 61, the cooling hole 213 could be blocked and thus the cooling of the battery cells 10 could be difficult.

The second bus bar 62 may include a hole 62h that is formed at a position corresponding to the cooling hole 213 formed at the holder 20. As described above, the second bus bar 62 is welded onto the bottom surface of the battery cells 10. If the hole 62h were not formed at the second bus bar 62, the cooling hole 213 could be blocked and thus the cooling of the battery cells 10 could be difficult.

Although the present embodiment illustrates a case where the battery cells 10 are connected in parallel, in other implementations, the battery cells 10 may be connected in series, or in a series-parallel.

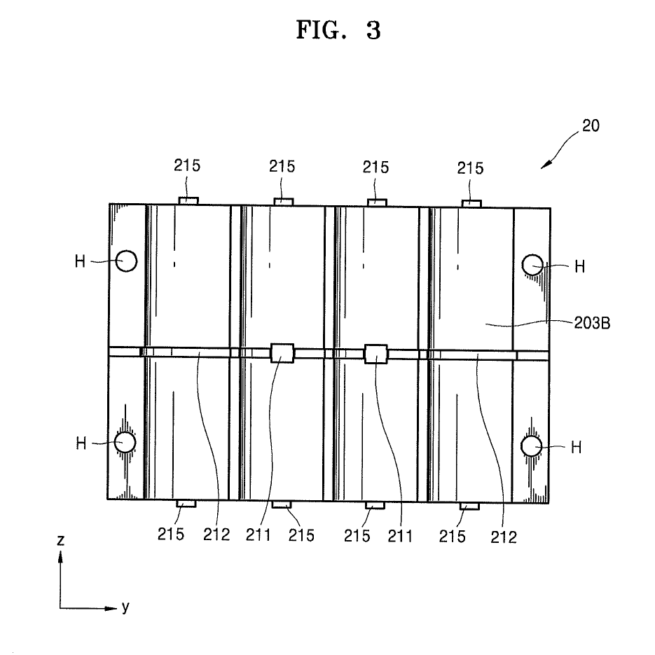

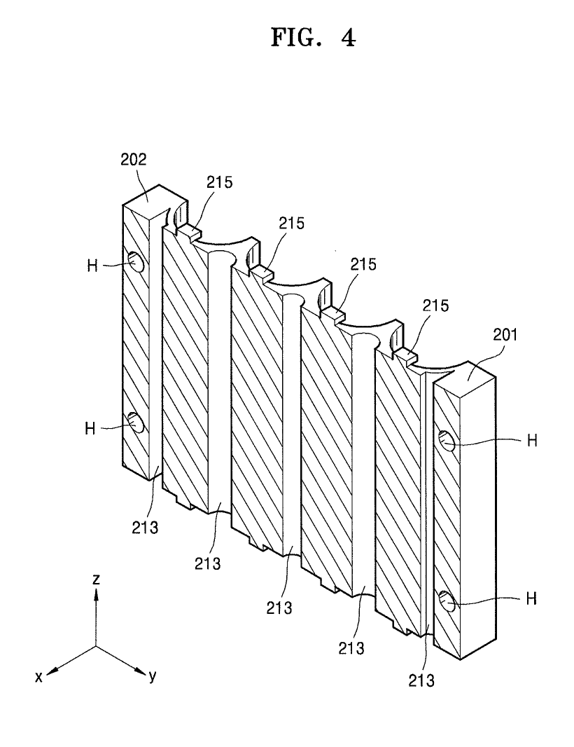

FIG. 2 illustrates a detailed perspective view depicting the holder 20 and the temperature unit 30 illustrated in FIG. 1. FIG. 3 illustrates a front view of the holder 20 depicted in FIG. 2. FIG. 4 illustrates a perspective view taken along line IV-IV in FIG. 2.

Referring to FIGS. 2 to 4, the holder 20 may include first and second edge portions 201 and 202 that are formed at both sides of the holder, and a partition portion 203 that couples the first and second edge portions 201 and 202.

The first and second edge portions 201 and 202 may be disposed at both sides of the holder 20. As described above with reference to FIG. 1, the first and second edge portions 201 and 202 may include the through hole H that extends in the x direction such that the coupling members 51 and 52, for example, the bolt 51, may pass therethrough.

The first and second edge portions 201 and 202 may protrude (or extend) in the ±x directions. The first and second edge portions 201 and 202 may protrude in the −x direction, which is a direction from the partition portion 203 toward the battery cells forming the first row, and the x direction, which is a direction from the partition portion 203 toward the battery cells forming the second row. For example, each of the ends of the first edge portion 201 may protrude by the radius of the battery cell 10 in the x direction and the −x direction. Likewise, each of the ends of the second edge portion 202 may protrude by the radius of the battery cell 10 in the x direction and the −x direction.

Rows of the battery cells 10 may be disposed in parallel to each other, Accordingly, the holders 20 disposed between the rows of battery cells 10 may also be disposed in parallel to each other as illustrated in FIG. 1. Referring to FIG. 1, the battery cells 10 forming one row may be disposed between the adjacent holders 20. As described above, the ends of the first and second edge portions 201 and 202 may protrude by the radius of the battery cell 10 in the x direction and the −x direction. Accordingly, the edge portions 201 and 202, for example, the ends of the first and second edge portions 201 and 202, of the neighboring holders 20 may contact each other. For example, the first edge portions 201 of the neighboring holders 20 may contact each other, and the second edge portions 202 of the neighboring holders 20 may contact each other.

The partition portion 203 may extend in the y direction to couple the first and second edge portions 201 and 202. A first surface 203A of the partition portion 203 may contact the side surfaces of the battery cells 10 of the first row R1, and a second surface 203B of the partition portion 203, which is opposite to the first surface 203A, may contact the side surfaces of the battery cells 10 of the second row R2.

According to an embodiment, the battery cells 10 may be cylindrical. Accordingly, the first and second surfaces 203A and 203B of the partition portion 203 may include a recess having a shape corresponding to the side surface of the battery cells 10. Due to the recess corresponding to the side surface of the battery cells 10, the partition portion 203 may include a thick portion 203T that is relatively thick, and a thin portion 203t that is relatively thin. As illustrated, for example, in FIG. 1, the thick portion 203T of the partition portions 203 of adjacent holders 20 may contact each other. For example, the thick portions 203T of adjacent holders 20 may contact each other between adjacent battery cells 10 in a row.

The first receiving groove 211 configured to receive the temperature device 31 may be formed on the first and second surfaces 203A and 203B of the holder 20, for example, on the first and second surfaces 203A and 203B of the partition portion 203. The first receiving groove 211 may be formed at a center region of at least one of the first and second surfaces 203A and 203B such that the temperature of a battery cell 10 disposed at inner side of a row may be measured. For example, when four (even-numbered) battery cells 10 form one row as in the present embodiment, the first receiving groove 211 may be formed at a position corresponding to the side surface of the inner second battery cell 10 or the third battery cell 10. In another implementation, when five (odd-numbered) battery cells 10 form one row, the first receiving groove 211 may be formed at a position corresponding to the side surface of the center third battery cell 10.

The depth of the first receiving groove 211 may be less than or equal to the thickness of the temperature device 31 such that the temperature device 31 seated in the first receiving groove 211 may directly contact the side surface of the battery cell 10.

The wire 32 and the connector 33 may be coupled to one end of the temperature device 31. The connector 33 may be exposed to the outside such that the connector 33 may be connected to an external protection circuit module (not illustrated). At least one of the first and second surfaces 203A and 203B of the holder 20 may further include a second receiving groove 212 that is coupled to the first receiving groove 211 and configured to receive the wire 32.

FIGS. 2 and 3 illustrate a case where the first receiving groove 211 and the second receiving groove 212 coupled to the first receiving groove 211, are formed as two pairs. As illustrated in FIGS. 2 and 3, when two pairs of first and second receiving grooves 211 and 212 are formed, the temperature unit 30 may be received in any one of the two pairs of first and second receiving grooves 211 and 212. In other implementations, only one pair of first and second receiving grooves 211 and 212 may be provided.

The partition portion 203 may include a cooling hole 213 that extends parallel to the longitudinal direction (z direction) of the battery cell 10. The cooling hole 213 may have a structure that prevents the overheating of the battery cells 10. The cooling hole 213 may be formed in the longitudinal direction (z direction) of the battery cell 10. As described above, the first and second end holders 41 and 42, the holder 20, and the battery cells 10 may be closely assembled by the coupling members 51 and 52. IF the heat generated in the battery cells 10 is not dissipated for a long period of time, the battery cells 10 may be deteriorated.

According to the present embodiment, in order to prevent the deterioration of the battery cells 10, the cooling hole 213 may be formed at a position adjacent to the battery cells 10, for example, at the thick portion 203T of the partition portion 203. According to the present embodiment, the cooling hole 213 may be provided at the thick portion 203T formed between side surfaces (i.e., first and second surfaces 203A and 203B) of the partition portions 203 that include a recess corresponding to the side surface of the battery cells 10. Accordingly, space utilization may be maximized. That is, it may not be necessary to increase the thickness of the holder 20 in order to form the cooling hole 213.

The top and bottom surfaces of the holder 20, for example, the top and bottom surfaces of the partition portion 203 may include a stopper 215 that contacts the top and bottom surfaces of the battery cell 10. As described above, the battery cells 10 may be disposed such that the side surface of the battery cells 10 contacts the holder 20, and the battery pack may be assembled by the coupling members 51 and 52. Accordingly, the battery cells 10 are unlikely to become detached in the lateral direction. However, the contact of the side surfaces of the battery cells 10 with the holder 20 does not prevent the battery cells 10 from being separated from the holder 20 in z direction. Accordingly, the holder 20 may include the stopper 215 such that the battery cells 10 are not separated from the holder 20 in the direction of the top surface or bottom surface of the battery cells 10. Although it is illustrated that the stopper 215 is formed at the thin portion 203t of the partition portion 203, in other implementations, the stopper 215 may be in other suitable positions as long as the stopper 215 contacts the top surface and bottom surface of the battery cells 10 to prevent the battery cells 10 from being detached from the holder 20.

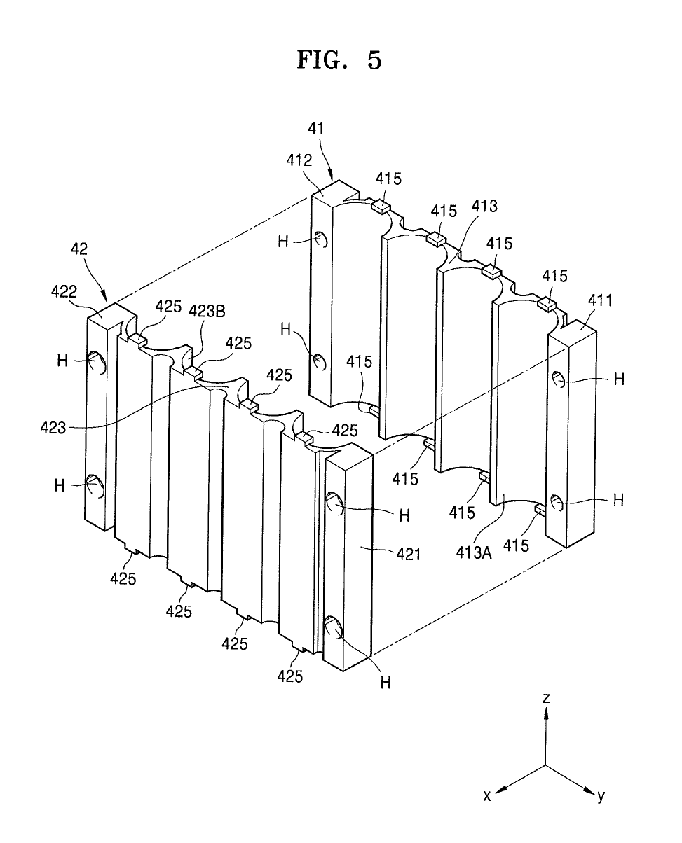

FIG. 5 illustrates a detailed perspective view depicting the first and second end holders 41 and 42 according to an embodiment.

Referring to FIG. 5, the first and second end holders 41 and 42 may be disposed such that the surfaces contacting the side surface of the battery cells 10 face each other. When the battery cells 10 are cylindrical as in the present embodiment, one surface 413A of the first end holder 41 and one surface 423B of the second end holder 42 may include a recess having a shape corresponding to the side surface of the battery cells.

The first and second end holders 41 and 42 may respectively include first and second edges 411, 412, 421 and 422 and partition portions 413 and 423.

The first and second edge portions 411 and 412 of the first end holder 41 may be disposed at both sides of the first end holder 41 and may include a through hole H that extends in the x direction such that the coupling members 51 and 52, for example, the bolt 51, may pass therethrough, as described above.

The first and second edge portions 421 and 422 of the second end holder 42 may be disposed at both sides of the second end holder 42 and may include a through hole H that extends in the x direction such that the coupling members 51 and 52, for example, the bolt 51, may pass therethrough.

The first and second edge portions 411 and 412 of the first end holder 41 may protrude in the x direction. For example, ends of the first and second edge portions 411 and 412 of the first end holder 41 may protrude by the radius of the battery cell 10 in the x direction.

The first and second edge portions 421 and 422 of the second end holder 42 may protrude in the −x direction. For example, ends of the first and second edge portions 421 and 422 of the second end holder 42 may protrude by the radius of the battery cell 10 in the −x direction.

The partition portions 413 and 423 of the first and second end holders 41 and 42 may extend in the y direction. As described above, one surface of the partition portions 413 and 423 may include a recess having a shape corresponding to the side surface of the battery cells 10 such that the surface may directly contact the side surface of the battery cells 10.

The top and bottom surfaces of the first and second end holders 41 and 42, for example, the top and bottom surfaces of the partition portions 413 and 423 may include a stopper 215 that contacts the top and bottom surfaces of the battery cell 10. As described above, the battery cells 10 may be disposed such that the side surface of the battery cells 10 contacts the first and second end holders 41 and 42, and the battery pack may be assembled by the coupling members 51 and 52. Accordingly, the battery cells 10 are unlikely to become detached in the lateral direction. However, the contact of the side surfaces of the battery cells 10 with the holder 20 does not prevent the battery cells 10 from being separated from the first and second end holders 41 and 42 in z direction. Therefore, the first and second end holders 41 and 42 may include stoppers 415 and 425 such that separation of the battery cells 10 from the first and second end holders 41 and 42 in the direction of the top surface or bottom surface of the battery cells may be prevented or avoided 10.

As described above, according to the embodiments, the battery pack may be assembled with the holder 20 interposed between the row of battery cells 10 and the holder 20 may include the first receiving groove 211 that receives the temperature device 31 and the cooling hole 213 that prevents overheating of the battery cell 10. Accordingly, the battery pack may easily control the temperature of the battery cells 10 while receiving the battery cells 10.

By way of summation and review, secondary batteries may be used for a long period of time through multiple charge/discharge operations. Accordingly, the stability of secondary batteries is a matter of great interest. When heat generated during the charge/discharge operation of the secondary batteries, that is, the temperature of the secondary batteries is not properly managed, the secondary batteries may deteriorate, and the lifetime of the secondary batteries may be reduced. Therefore, temperature control in the secondary batteries is desirable. According to the one or more of the above embodiments, the battery packs may easily control the temperature of the battery cells while receiving the battery cells.

Example embodiments have been disclosed herein, and although specific terms are employed, they are used and are to be interpreted in a generic and descriptive sense only and not for purpose of limitation. Accordingly, it will be understood by those of skill in the art that various changes in form and details may be made without departing from the spirit and scope as set forth in the following claims.

What is claimed is:

1. A battery pack, comprising:
battery cells in a plurality of neighboring rows arranged in a first direction, each row of the neighboring rows including a plurality of the battery cells arranged in a second direction;
a holder between the neighboring rows of the battery cells, the holder having a first surface contacting a side surface of each of the battery cells forming a first row among the neighboring rows and a second surface contacting a side surface of each of the battery cells forming a second row among the neighboring rows; and
a temperature device that measures a temperature of the battery cells,
wherein the holder includes:
a receiving groove extending inwardly from at least one of the first surface and the second surface of the holder to receive the temperature device, and
a cooling hole that passes through the holder to enable a fluid to enter and exit the holder.

2. The battery pack as claimed in claim 1, wherein a depth of the receiving groove from the first surface or the second surface of the holder is equal to or less than a thickness of the temperature device.

3. The battery pack as claimed in claim 1, wherein:
the receiving groove is a first receiving groove,
the temperature device is connected to a wire that extends toward an outside, and
the holder further includes a second receiving groove that is coupled to the first receiving groove and receives the wire.

4. The battery pack as claimed in claim 1, wherein:
the first row and the second row each include outer battery cells at respective outer sides of the first row and the second row and one or more inner battery cells located inwardly from the outer battery cells in the first row and the second row, and
the temperature device contacts the side surface of an inner battery cell among the one or more inner battery cells in the first row or the second row.

5. The battery pack as claimed in claim 1, wherein:
the battery cells are cylindrical battery cells each extending in a third direction orthogonal to the first direction and the second direction, and
the holder has a height in the third direction greater than or equal to a height of the battery cells.

6. The battery pack as claimed in claim 5, wherein the cooling hole passes through the holder in the third direction.

7. The battery pack as claimed in claim 5, wherein the first surface and the second surface of the holder includes recesses, each conforming to the side surface of one of the battery cells.

8. The battery pack as claimed in claim 7, wherein the holder further includes stoppers that contact at least one of top surfaces and bottom surfaces of the battery cells of the first row and the second row.

9. The battery pack as claimed in claim 1, further comprising a bus bar that electrically connects the battery cells, the bus bar covering the battery cells and the holder and including a hole formed at a position corresponding to the cooling hole.

10. The battery pack as claimed in claim 1, wherein the fluid is air.

11. The battery pack as claimed in claim 1, further including:
a pair of end holders at respective ends of the battery pack in the first direction, the pair of end holders and the holder being coupled by a coupling member that passes in the first direction through the pair of end holders and the holder.

12. The battery pack as claimed in claim 11, wherein the holder includes:
a first edge portion and a second edge portion at respective ends of the holder in the second direction, and
a partition portion that couples the first edge portion and the second edge portion, the partition portion including the receiving groove and the cooling hole.

13. The battery pack as claimed in claim 12, wherein each of the first edge portion and the second edge portion protrudes in the first direction from the partition portion toward the battery cells forming the first row and toward the battery cells forming the second row.

14. The battery pack as claimed in claim 13, wherein each of the first edge portion and second edge portion protrudes in the first direction toward the battery cells forming the first row by a distance corresponding to a radius of the battery cells of the first row and protrudes in the first direction toward the battery cells forming the second row by a distance corresponding to a radius of the battery cells of the second row.

15. The battery pack as claimed in claim 13, wherein:
the coupling member includes a plurality of coupling members, and
respective ones of the coupling members pass through the first edge portion or the second edge portion of the holder

16. The battery pack as claimed in claim 13, wherein
the battery cells are cylindrical,
the partition portion includes recesses conforming to the side surfaces of the battery cells of the first row and the second row, and
the partition portion includes a relatively thick portion and a relatively thin portion, the relatively thin portion being formed by the recesses.

17. The battery pack as claimed in claim 16, wherein the cooling hole is formed at the relatively thick portion.

18. The battery pack as claimed in claim 16, wherein:
the neighboring rows of the battery cells include three or more rows of the battery cells,
the holder includes a plurality of adjacent holders, each of the holders being between the neighboring rows of the battery cells,
the first edge portion of the adjacent holders contact each other and the second edge portion of the adjacent holders contact each other.

19. The battery pack as claimed in claim 18, wherein the relatively thick portion of each of the adjacent holders contact each other.
